(19) United States
(12) Patent Application Publication
(10) Pub. No.: US 2026/0035499 A1
(43) Pub. Date: Feb. 5, 2026

(54) NON-FLUOROSURFACTANT, PREPARATION METHOD THEREFOR, AND USE THEREOF

(71) Applicant: ZHONGHAO CHENGUANG RESEARCH INSTITUTE OF CHEMICAL INDUSTRY CO., LTD., Zigong, Sichuan (CN)

(72) Inventors: Zhongliang XIAO, Zigong, Sichuan (CN); Bo LIU, Zigong, Sichuan (CN); Jinlong YU, Zigong, Sichuan (CN); Ziqiang ZHONG, Zigong, Sichuan (CN); Zhoujun LIN, Zigong, Sichuan (CN); Liyi CHEN, Zigong, Sichuan (CN); Hui LI, Zigong, Sichuan (CN); Feiyang YE, Zigong, Sichuan (CN); Tingjian ZHANG, Zigong, Sichuan (CN)

(21) Appl. No.: 18/998,931

(22) PCT Filed: Jul. 26, 2022
(86) PCT No.: PCT/CN2022/107935

§ 371 Date: Jan. 27, 2025

(51) Int. Cl. C08F 228/02

(52) U.S. Cl. CPC C08F 228/02

(57) ABSTRACT

Provided in the present invention are a non-fluorosurfactant, a preparation method therefor, and the use thereof. The non-fluorosurfactant is a polymer, the main chain of which contains the following structural units: structural units A, structural units B, structural units C and structural units D, wherein the structural units D are linked to each other by means of (I), R₁, R₂, R₄, R₅, and R₆ are each independently a hydrogen atom or C₁-C₃ alkyl group, R₃ is a hydrogen atom, NH₄⁺, or a monovalent metal ion, and n is an integer of 10-150. The non-fluorosurfactant provided by the present invention has a good effect of reducing the surface tension of an aqueous phase system, and therefore can be used for preparing a fluorine-containing polymer in replacement of fluorine-containing surfactants.

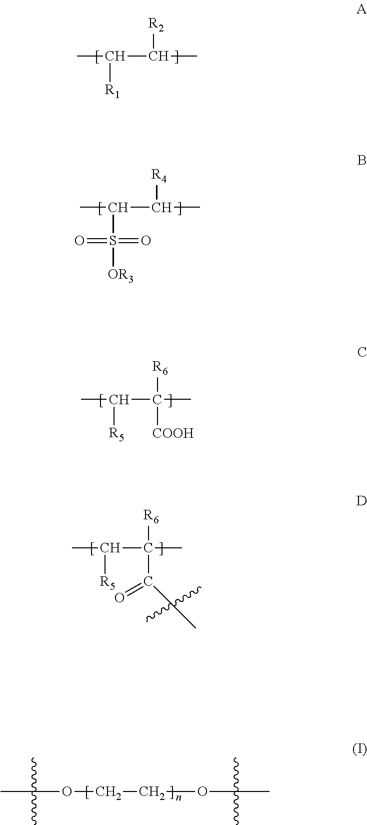

### FIELD OF THE INVENTION

The present application belongs to the technical field of chemical synthesis, and specifically relates to non-fluorosurfactant, preparation method therefor and use thereof.

### BACKGROUND OF THE INVENTION

Fluoropolymers have excellent heat resistance, chemical resistance, durability and weather resistance, etc. They are widely used in the fields such as chemical, petroleum, textile, food, paper, medicine, electronics and machinery. Such polymers mainly include polytetrafluoroethylene (PTFE), polyvinylidene fluoride (PVDF), polychlorotrifluoroethylene (PCTFE), polyvinyl fluoride (PVF), fluorinated ethylene propylene (FEP), and meltable polytetrafluoroethylene (PFA).

At present, industrial production of fluoropolymer is prepared by aqueous emulsion polymerization mainly using perfluorooctyl carboxylate (PFOA), perfluorooctyl sulfonate (PFOS) or derivatives thereof as surfactants. These two surfactants are organic pollutants found to be the most difficult to degrade in the world to date, they persist in the surrounding environment for a long time and have high bioaccumulation, and they are gradually banned by environmental protection organizations around the world. Many countries have done a lot of work and made great progress in developing new fluorocarbon surfactant to replace PFOS and PFOA. For example, CN103073410A discloses a method for the preparation of a fluoroether carboxylic acid surfactant, wherein of a fluoroether carboxylic acid is produced by the generation of a fluoroether acyl chloride and a fluoroether acyl fluoride via an ultraviolet light-initiated photochemical reaction of a fluoro-olefin monomer and oxygen, followed by hydrolysis. Patent CN114031762A discloses a preparation process of perfluoropolyether surfactant and the perfluoropolyether surfactant, in which a crude product is first obtained by photochemical reaction using hexafluoropropylene, chlorotrifluoroethylene, and oxygen, and then a perfluoropolyether surfactant is obtained by de-peroxygenation, hydrolysis, and neutralization.

However, the fluoropolymer produced with the above surfactants still has residual fluorine compound and is still bioaccumulative to a certain extent, which is not in line with the requirements of the development of green chemistry. Recently, international fluorine chemical giants Solvay and DuPont have announced the accelerated phase-out of fluorosurfactant to completely solve the problem of bioaccumulation of fluorosurfactant. Therefore, it is urgent to carry out research on non-fluorosurfactant.

### SUMMARY OF THE INVENTION

In view of the deficiencies of the related technology, an object of the present invention is to provide a non-fluorosurfactant, a preparation method therefor and use thereof. This non-fluorosurfactant has a good effect of lowering the surface tension of an aqueous phase system and can be used in place of fluorosurfactant for the preparation of fluoropolymer by aqueous emulsion polymerization.

To achieve this, the present invention utilizes the following technical solutions.

In a first aspect, the present invention provides a non-fluorosurfactant, and the non-fluorosurfactant is a polymer comprising the following structural units in its main chain:

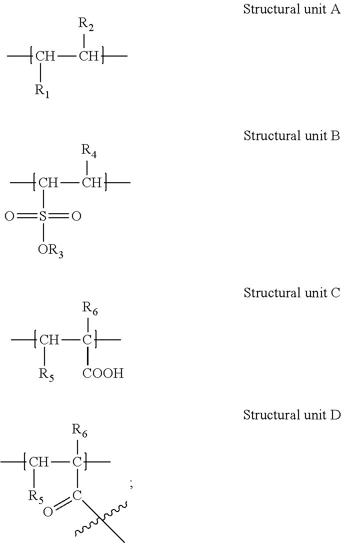

wherein, the structural units D are connected to each other via

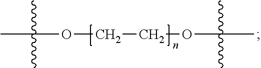

R₁, R₂, R₄, R₅, and R₆ are each independently a hydrogen atom or C₁-C₃ alkyl group;
R₃ is a hydrogen atom, NH₄⁺ or a monovalent metal ion; and
n is an integer from 10 to 150 (e.g., it may be 10, 15, 20, 30, 40, 50, 60, 80, 100, 120, 130, or 150, etc.).

In the present invention,

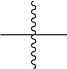

represents a connecting bond of a group.

In the present invention, the “non-fluoro” means free of fluorine. The structural formula of the non-fluorosurfactant provided according to the present invention is shown in the following formula I:

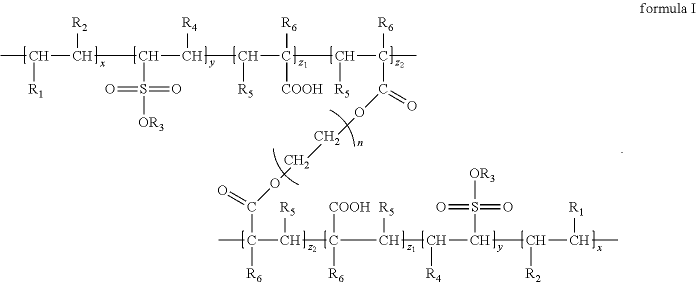

It should be noted that since a copolymer formed by the polymerization of a variety of monomers has different bonding manners such as alternating copolymerization, random copolymerization and block copolymerization, as well as different stereo configurations, which cannot be represented by a structural formula, formula I is only used to illustrate which structural units the molecular chain of the non-fluorosurfactant is composed of, and does not represent the real structure of the non-fluorosurfactant.

In some embodiments of the present invention, R₁, R₂, R₄, R₅, and R₆ are each independently a hydrogen atom, methyl, or ethyl.

In some embodiments of the present invention, the structural unit A, structural unit B, structural unit C. and structural unit D have a molar ratio of (1.0 to 1.6):(1.2 to 1.5):1:(0.2 to 0.6).

In some embodiments of the present invention, the non-fluorosurfactant has a molecular weight of 200,000 to 800.000; for example, the molecular weight may be 200,000, 250,000, 300,000, 350,000, 400,000, 450,000, 500,000, 550.000, 600,000, 650,000, 700,000, 750,000, or 800,000, etc.

In some embodiments of the present invention, the monovalent metal ion is a sodium ion or a potassium ion.

In a second aspect, the present invention provides a preparation method for a non-fluorosurfactant as described in the first aspect, and the preparation method comprises the following steps:
reacting compounds

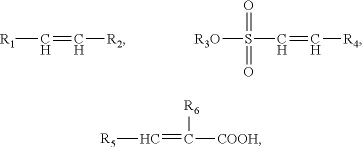

and polyethylene glycol as raw materials in water in the presence of an initiator, to produce the non-fluorosurfactant.

Wherein, polyethylene glycol (PEG) has a structural formula of

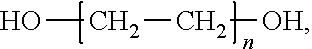

which links structural units D by esterification reaction with a carboxyl group. The polyethylene glycol employed in the present invention may be PEG-400, PEG-800, PEG-1000, PEG-2000, or PEG-4000, etc.

In some embodiments of the invention, the initiator is selected from one or more of ammonium persulfate, sodium persulfate, potassium persulfate, di-tert-butyl peroxide, and dibenzoyl peroxide.

In some embodiments of the present invention, the initiator is used in an amount of 0.1 to 0.5%, for example 0.1%, 0.15%, 0.2%, 0.25%, 0.3%, 0.35%, 0.4%, 0.45%, or 0.5%, etc., of the total mass of the compounds

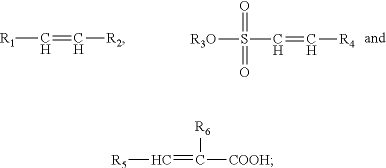

for example.

In some embodiments of the present invention, the compound

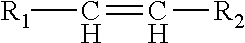

and polyethylene glycol are fed by one-time addition, and the compounds

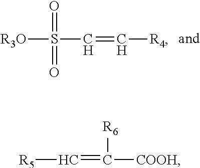

and the initiator are fed by dropwise addition in the form of an aqueous solution.

In some embodiments of the present invention, the dropwise addition is carried out for 0.5 to 1.5 h; for example, the time may be 0.5 h, 0.6 h, 0.8 h, 1 h, 1.2 h, 1.3 h, or 1.5 h, etc.

In some embodiments of the present invention, the reacting is carried out at a temperature of 60 to 120° C.; for example, the temperature may be 60° C., 70° C., 80° C., 90° C., 100° C., 110° C., or 120° C., etc.

In some embodiments of the present invention, the reacting is carried out for 4 to 10 h; for example, the time may be 4 h, 5 h, 6 h, 7 h, 8 h, 9 h, or 10 h, etc.

It is to be noted that in the present invention when the feed is carried out by means of dropwise addition, the time of the reacting of 4 to 10 h does not include the time of dropwise addition.

In some embodiments of the present invention, the preparation method for the non-fluorosurfactant may further comprise a purification operation to obtain a pure non-fluorosurfactant product.

The present invention has no particular limitations on the method of purification. Exemplarily, the purification may be carried out according to the following steps: after the reaction is complete, the lower organic phase solution is separated, and chloroform is added to obtain a mixed solution; the mixed solution is washed with saturated aqueous sodium sulfite, saturated brine, and deionized water, respectively, and separated to obtain a second organic phase solution; then the second organic phase solution is dried over anhydrous sodium sulfate; and finally, the non-fluorosurfactant is obtained via filtration and rotary evaporation.

In a third aspect, the present invention provides use of the non-fluorosurfactant as described in the first aspect in the preparation of fluoropolymer by aqueous emulsion polymerization.

In a fourth aspect, the present invention provides a preparation method for a fluoropolymer, the preparation method comprises: subjecting a fluorine-containing monomer to aqueous emulsion polymerization in an aqueous phase comprising the non-fluorosurfactant as described in the first aspect to produce the fluoropolymer.

In some embodiments of the present invention, the fluorine-containing monomer is selected from one or more of tetrafluoroethylene, hexafluoropropylene, vinyl fluoride, vinylidene fluoride, trifluoroethylene, and chlorotrifluoroethylene.

In some embodiments of the present invention, the non-fluorosurfactant is used in an amount of 0.008 to 0.2%, for example 0.008%, 0.01%, 0.02%, 0.03%, 0.05%, 0.06%, 0.08%, 0.1%, 0.12%, 0.13%, 0.15%, 0.16%, 0.18%, or 0.2%, etc., of the mass of the fluoropolymer.

The present invention has the following beneficial effects as compared to related technologies:

The non-fluorosurfactant provided according to the present invention has a good effect of lowering the surface tension of an aqueous phase system, and can dramatically lower the surface tension of the aqueous phase at a lower concentration. The non-fluorosurfactant is more environmentally friendly than a fluorosurfactant, and can be used in place of fluorosurfactant for the preparation of fluoropolymer by aqueous emulsion polymerization, and the prepared fluoropolymer emulsion is stable without demulsification.

### DETAILED DESCRIPTION OF THE EMBODIMENTS

The technical solution of the present invention is further described below by way of specific embodiments. It should be apparent to those skilled in the art that the specific embodiments described are merely an aid to understanding the invention and should not be regarded as a specific limitation of the invention.

### Example 1

This example provides a non-fluorosurfactant, which is prepared as follows:

500 mL of deionized water and 1600 g of polyethylene glycol 800 were added to a 5 L high-pressure reactor, and 896 g of CH₃CH₂CH═CH₂ was charged into the reactor after three nitrogen displacements. A monomer solution (360 g of sodium vinylsulfonate and 860 g of CH₃CH═CHCOOH dissolved in 500 mL of deionized water) and an initiator solution (8 g of ammonium persulfate dissolved in 100 mL of deionized water) were added to the reactor simultaneously and slowly using a metering pump at 80° C., and the addition was controlled to be completed within 1 h. After the feeding was completed, the reaction was carried out at 120° C. for 4 h. After the reaction was complete, the unreacted gas was discharged, and the lower organic phase solution was separated using a partition funnel, and 500 mL of chloroform was added to the organic phase to obtain a mixed solution; the mixed solution was washed with saturated aqueous sodium sulfite, saturated brine, and deionized water, respectively, and separated to obtain an organic phase solution; then the resulting organic phase solution was dried over anhydrous sodium sulfate; and finally, after filtration and rotary evaporation, the non-fluorosurfactant D1 was obtained, and its number average molecular weight was measured to be 320000, and its HLB value was 17.5.

### Example 2

This example provides a non-fluorosurfactant, which is prepared as follows:

500 mL of deionized water and 3200 g of polyethylene glycol 800 were added to a 5 L high-pressure reactor, and 336 g of ethylene was charged into the reactor after three nitrogen displacements. A monomer solution (2175 g of sodium 1-methylethenylsulfonate and 710 g of acrylic acid dissolved in 500 mL of deionized water) and an initiator solution (16 g of sodium persulfate dissolved in 100 mL of deionized water) were added to the reactor simultaneously and slowly using a metering pump at 80° C., and the addition was controlled to be completed within 1 h. After the feeding was completed, the reaction was carried out at 100° C. or 6 h. of After the reaction was complete, the unreacted gas was discharged, and the lower organic phase solution was separated using a partition funnel, and 500 mL of chloroform was added to the organic phase to obtain a mixed solution; the mixed solution was washed with saturated aqueous sodium sulfite, saturated brine, and deionized water, respectively, and separated to obtain an organic phase solution; then the resulting organic phase was dried over anhydrous sodium sulfate; and finally, after filtration and rotary evaporation, the non-fluorosurfactant D2 was obtained, and its number average molecular weight was measured to be 210000, and its HLB value was 16.4.

### Example 3

This example provides a non-fluorosurfactant, which is prepared as follows:

500 mL of deionized water and 2000 g of polyethylene glycol 2000 were added to a 5 L high-pressure reactor, and 710 g of CH₃CH═CHCH₂CH₃ was charged into the reactor after three nitrogen displacements. The monomer solution (1896 g of sodium 1-methacrylenesulfonate and 710 g of acrylic acid dissolved in 500 mL of deionized water) and an initiator solution (4 g of potassium persulfate dissolved in 100 mL of deionized water) were added to the reactor simultaneously and slowly using a metering pump at 80° C., and the addition was controlled to be completed within 1 h. After the feeding was completed, the reaction was carried out at 110° C. for 5 h. After the reaction was complete, the unreacted gas was discharged, and the lower organic phase solution was separated using a partition funnel, and 500 mL of chloroform was added to the organic phase to obtain a mixed solution; the mixed solution was washed with saturated aqueous sodium sulfite, saturated brine, and deionized water, respectively, and separated to obtain an organic phase solution; then the resulting organic phase solution was dried over anhydrous sodium sulfate; and finally, after filtration and rotary evaporation, the non-fluorosurfactant D3 was obtained, and its number average molecular weight was measured to be 550000, and its HLB value was 15.9.

### Example 4

This example provides a non-fluorosurfactant, which is prepared as follows:

500 mL of deionized water and 8000 g of polyethylene glycol 4000 were added to a 5 L high-pressure reactor, and 784 g of CH₂CH₂CH═CH₂ was charged into the reactor after three nitrogen displacements. A monomer solution (1898 g of potassium vinyl sulfonate and 1000 g of CH₃CH₂CH═CH—COOH dissolved in 500 mL of deionized water) and 7 g of di-tert-butyl peroxide initiator were added to the reactor simultaneously and slowly using a metering pump at 80° C., and the addition was controlled to be completed in 1 h. After the feeding was completed, the reaction was carried out at 120° C. for 4 h. of After the reaction was complete, the unreacted gas was discharged, and the lower organic phase solution was separated using a partition funnel, and 500 mL of chloroform was added to the organic phase to obtain a mixed solution; the mixed solution was washed with saturated aqueous sodium sulfite, saturated brine, and deionized water, respectively, and separated to obtain an organic phase solution; then the resulting organic phase solution was dried over anhydrous sodium sulfate; and finally, after filtration and rotary evaporation, the non-fluorosurfactant D4 was obtained, and its number average molecular weight was measured to be 460000, and its HLB value was 18.3.

### Application Examples 1 to 4

In Application Examples 1 to 4, polyfluorinated ethylene propylene was prepared using the non-fluorosurfactants provided in Examples 1 to 4, respectively, by the following steps:

30 kg of deionized water was added into a 50 L reactor, the reactor was vacuumed and replaced with N₂ until the oxygen content was ≤30 ppm. 1.8 g of the respective non-fluorosurfactant provided in Examples 1 to 4 was added to the reactor respectively, the reactor was heated to 80° C., the initial mixed monomer of tetrafluoroethylene and hexafluoropropylene (the volume ratio of tetrafluoroethylene to hexafluoropropylene was 32:68) was charged until the pressure inside the reactor reached 3.5 Mpa, 20 g of ammonium persulfate dissolved in 100 mL of water was added, and the pressure inside the reactor was controlled to 3.8 MPa by supplementing the mixed monomer of tetrafluoroethylene and hexafluoropropylene (the volume ratio of tetrafluoroethylene to hexafluoropropylene was 96:4), and the reaction was terminated when the solid content of the emulsion reached 30%, to yield polyfluorinated ethylene propylene emulsion, and no signs of condensation or sedimentation of the emulsion were observed.

Emulsion stability test: the test was carried out according to GB/T1603-2001 test standards, and the test results are shown in Table 1.

TABLE 1
Results of Emulsion stability test

| No. | Surfactant | Emulsion stabilization time/s |
|---|---|---|
| Application Example 1 | DI | 420 ± 8 |
| Application Example 2 | D2 | 450 ± 6 |
| Application Example 3 | D3 | 460 ± 10 |
| Application Example 4 | D4 | 430 ± 8 |

As can be seen from the state of the emulsions prepared in Application Examples 1 to 4 and the test results in Table 1, the non-fluorosurfactant provided according to the present invention can be used in the aqueous emulsion polymerization of fluoropolymer and the emulsion formed therefrom was well stabilized.

Although the present invention has been described in detail above with general description, specific embodiments and tests, some modifications or improvements can be made on the basis of the present invention, as will be obvious to those skilled in the art. Therefore, these modifications or improvements made without departing from the spirit of the present invention fall within the scope of the claimed protection of the present invention.

1. A non-fluorosurfactant, characterized in that the non-fluorosurfactant is a polymer containing the following structural units in its main chain: 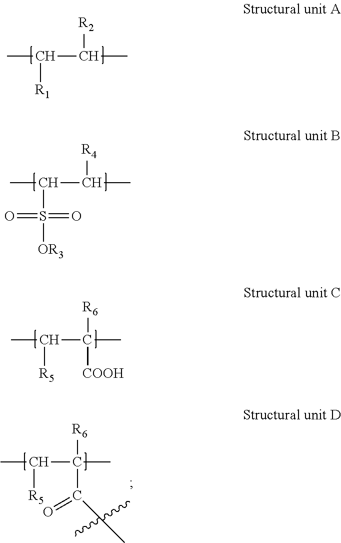
wherein, the structural units D are connected to each other via 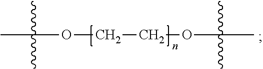
R₁, R₂, R₄, R₅, and R₆ are each independently a hydrogen atom or C₁-C₃ alkyl group;
R₃ is a hydrogen atom, NH₄⁺ or a monovalent metal ion; and
n is an integer from 10 to 150.

2. The non-fluorosurfactant according to claim 1, wherein, R₁, R₂, R₄, R₅, and R₆ are each independently a hydrogen atom, methyl, or ethyl.

3. The non-fluorosurfactant according to claim 1, wherein, the structural unit A, structural unit B, structural unit C, and structural unit D have a molar ratio of (1.0 to 1.6):(1.2 to 1.5):1:(0.2 to 0.6).

4. The non-fluorosurfactant according to claim 1, wherein, the non-fluorosurfactant has a number average molecular weight of 200,000 to 800,000.

5. The non-fluorosurfactant according to claim 1, wherein, the monovalent metal ion is a sodium ion or a potassium ion.

6. A preparation method for the non-fluorosurfactant according to claim 1, characterized in that the preparation method comprises the following steps:
reacting compounds 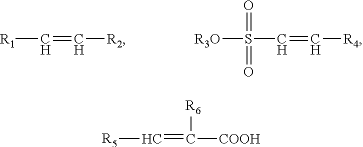
and polyethylene glycol as raw materials in water in the presence of an initiator, to produce the non-fluorosurfactant.

7. The preparation method according to claim 6, wherein, the initiator is selected from one or more of ammonium persulfate, sodium persulfate, potassium persulfate, di-tert-butyl peroxide, and dibenzoyl peroxide;
preferably, the initiator is used in an amount of 0.1 to 0.5% of the total mass of the compounds 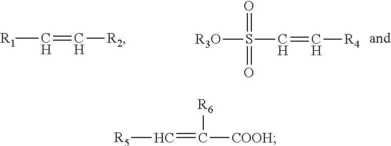
preferably, the compound 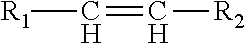
and polyethylene glycol are fed by one-time addition, and the compounds 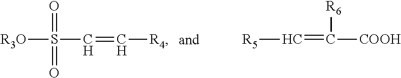
and the initiator are fed by dropwise addition in the form of an aqueous solution;
preferably, the dropwise addition is carried out for 0.5 to 1.5 h.

8. The preparation method according to claim 6, wherein, the reacting is carried out at a temperature of 60 to 120° C.;
preferably, the reacting is carried out for 4 to 10 h.

9. Use of the non-fluorosurfactant according to claim 1 in the preparation of a fluoropolymer by aqueous emulsion polymerization.

10. A preparation method for a fluoropolymer, characterized in that the preparation method comprises: subjecting a fluorine-containing monomer to aqueous emulsion polymerization in an aqueous phase comprising the non-fluorosurfactant according to claim 1 to produce the fluoropolymer;
preferably, the fluorine-containing monomer is selected from one or more of tetrafluoroethylene, hexafluoropropylene, vinyl fluoride, vinylidene fluoride, trifluoroethylene, and chlorotrifluoroethylene;
preferably, the non-fluorosurfactant is used in an amount of 0.008 to 0.02% by mass of the fluoropolymer.
